(19) United States
(12) Patent Application Publication
(10) Pub. No.: US 2023/0091239 A1
(43) Pub. Date: Mar. 23, 2023

(54) SYSTEM AND METHOD TO DETECT USER-AUTOMATION EXPECTATIONS GAP

(71) Applicant: GM Global Technology Operations LLC, Detroit, MI (US)

(72) Inventors: Claudia Goldman-Shenhar, Mevasseret Zion (IL); Ronit Bustin, Kfar Saba (IL)

(21) Appl. No.: 17/481,724

(22) Filed: Sep. 22, 2021

(51) Int. Cl. B60W 60/00; B60W 50/14; G06N 7/00

(52) U.S. Cl. CPC B60W 60/0053; B60W 50/14; G06N 7/005; B60W 2050/007

(57) ABSTRACT

A vehicle includes a system method of operating the vehicle. The system includes a processor. The processor is configured to determine a machine-selected action for the vehicle in a current state and an actual next state for the vehicle resulting from the machine-selected action, determine, using a user model, a user-expected action for the vehicle in the first current state and a user-expected next state for the vehicle resulting from applying the machine-selected action, determine a gap value based on at least one of the user-expected action, the machine-selected action, the actual next state and the user-expected next state, and output a signal when the gap value meets a threshold.

### INTRODUCTION

The subject disclosure relates to autonomous vehicles and their methods of operation and, in particular, to a system and method for performing an action at an autonomous vehicle that reduces an uncertainty and anxiety in a human passenger of the autonomous vehicle.

An autonomous vehicle performs various maneuvers that are based on a state of the vehicle and a traffic scenario. The vehicle plans the maneuvers in order to move itself safely through traffic. However, an action chosen by the vehicle can be different than an action that a human would select in the same situation or an action that the human would expect the vehicle to select. Thus, a user traveling in the vehicle may develop a level of surprise, uncertainty and/or anxiety when the vehicle performs the action. Accordingly, it is desirable to provide a system and method for determining a difference or gap between an expectation of the user in a given traffic scenario and an intended action of the vehicle in the scenario.

### SUMMARY

In one exemplary embodiment, a method of operating a vehicle is disclosed. A machine-selected action for the vehicle in a current state and an actual next state for the vehicle resulting from the machine-selected action is determined. Using a user model, a user-expected action for the vehicle in the current state and a user-expected next state for the vehicle resulting from applying the machine-selected action are determined. A gap value is determined based on at least one of the user-expected action, the machine-selected action, the actual next state, and the user-expected next state. A signal is output when the gap value meets a threshold.

In addition to one or more of the features described herein, the user model includes a first model characterizing the user-expected action for the vehicle in the current state and a second model characterizing the user-expected next state. Determining the gap value further includes at least one of determining a difference between the user-expected action and the machine-selected action, determining the difference between the user-expected next state the actual next state, determining the difference between a distribution over the user-expected action and the machine-selected action, and determining the difference between the distribution over the user-expected next state the actual next state. The method further includes creating the user model by at least one of polling a reaction of a test subject to a traffic scenario, and applying constraints on a Markov Decision Process to create a free energy model having one or more hyperparameters and polling the reaction of the test subject to determine the values of the one or more hyperparameters. The method further includes adjusting the value of the one or more hyperparameter of the user model to fit a behavior of a selected user. Outputting the signal further comprises at least one of providing an explanation to a user about the gap value, adjusting the machine-selected action to correspond to the user-expected action, transferring control of the vehicle to the user, and providing the gap value to a traffic controller. The method further includes adjusting the user model to suit a knowledge of a user.

In another exemplary embodiment, a system for operating a vehicle is disclosed. The system includes a processor configured to determine a machine-selected action for the vehicle in a current state and an actual next state for the vehicle resulting from the machine-selected action, determine, using a user model, a user-expected action for the vehicle in the current state and a user-expected next state for the vehicle resulting from applying the machine-selected action, determine a gap value based on at least one of the user-expected action, the machine-selected action, the actual next state and the user-expected next state, and output a signal when the gap value meets a threshold.

In addition to one or more of the features described herein, the user model includes a first model characterizing the user-expected action for the vehicle in the current state and a second model characterizing the user-expected next state. The processor is further configured to determine the gap value by determining at least one of a difference between the user-expected action and the machine-selected action, the difference between the user-expected next state the actual next state, the difference between a distribution over the user-expected action and the machine-selected action, and the difference between the distribution over the user-expected next state the actual next state. The processor is further configured to create the user model by at least one of polling a reaction of a test subject to a traffic scenario, and applying constraints on a Markov Decision Process to create a free energy model having one or more hyperparameters and polling the reaction of the test subject to determine the values of the one or more hyperparameters. The processor is further configured to adjust the value of the one or more hyperparameters of the user model to fit a behavior of a selected user. The processor is further configured to output the signal by performing at least one of providing an explanation to a user about the gap value, adjusting the machine-selected action to correspond to the user-expected action, transferring control of the vehicle to the user, and providing the gap value to a traffic controller. The processor is further configured to adjust the user model to suit a knowledge of a user.

In another exemplary embodiment, a vehicle is disclosed. The vehicle includes a processor configured to determine a machine-selected action for the vehicle in a current state and an actual next state for the vehicle resulting from the machine-selected action, determine, using a user model, a user-expected action for the vehicle in the current state and a user-expected next state for the vehicle resulting from applying the machine-selected action, determine a gap value based on at least one of the user-expected action, the machine-selected action, the actual next state and the user-expected next state, and output a signal when the gap value meets a threshold.

In addition to one or more of the features described herein, the user model includes a first model characterizing the user-expected action for the vehicle in the current state and a second model characterizing the user-expected next state. The processor is further configured to determine the gap value by determining at least one of a difference between the user-expected action and the machine-selected action, the difference between the user-expected next state the actual next state, the difference between a distribution over the user-expected action and the machine-selected action, and the difference between the distribution over the user-expected next state the actual next state. The processor is further configured to create the user model by at least one of polling a reaction of a test subject to a traffic scenario, and applying constraints on a Markov Decision Process to create a free energy model having one or more hyperparameters and polling the reaction of the test subject to determine the values of the one or more hyperparameters. The processor is further configured to output the signal to perform at least one of providing an explanation to a user about the gap value, adjusting the machine-selected action to correspond to a user-expected action, transferring control of the vehicle to the user, and providing the gap value to a traffic controller. The processor is further configured to adjust the user model to suit a knowledge of a user.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an autonomous vehicle in an illustrative embodiment;

FIG. 2 shows a traffic scenario for illustrating operation of the system disclosed herein;

FIG. 3 shows the traffic scenario of FIG. 2 and a second action that can be performed by the host vehicle;

FIG. 4 shows a flowchart illustrating a process of determining a difference between a human response to a traffic scenario and a vehicle response to the traffic scenario;

FIG. 5 shows a schematic diagram of a system that determines a difference between machine behavior and human behavior with respect to a traffic scenario;

FIG. 6 shows a flowchart of a first method for determining the user model using a non-information theoretic model, in an illustrative embodiment;

FIG. 7 shows a flowchart of a second method for determining the user model using an information theoretic model, in an illustrative embodiment;

FIG. 8 shows a flowchart of a method for maintaining or adjusting the user model via the information theoretic model created in FIG. 7;

FIG. 9 shows a flowchart of a method for using the user model to generate actions and next states via the non-information theoretic model of FIG. 6;

FIG. 10 shows a flowchart of a method for using the information theoretic model to generate actions and next states;

FIG. 11 shows a flowchart illustrating operation of the machine system for selecting an optimal action for the vehicle;

FIG. 12 shows a flowchart illustrating operation of the gap detector of FIG. 5;

FIG. 13 shows a gridworld environment suitable for use in creating an information-theoretic model, in an illustrative embodiment;

FIG. 14 shows a graph of expected value vs. entropy for the gridworld environment of FIG. 13; and

FIG. 15 shows a flowchart for a method of adjusting the state transition model to obtain a smoothed transition model for a particular user.

### DETAILED DESCRIPTION

The following description is merely exemplary in nature and is not intended to limit the present disclosure, its application or uses. It should be understood that throughout the drawings, corresponding reference numerals indicate like or corresponding parts and features.

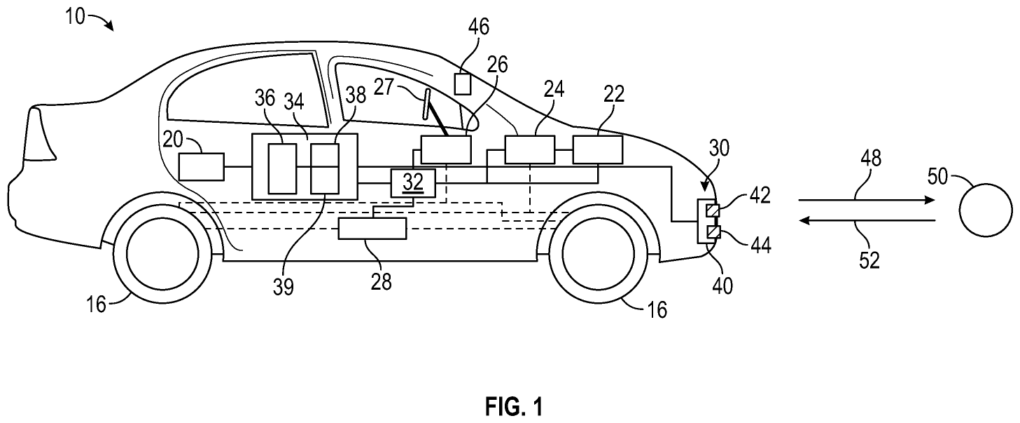

In accordance with an exemplary embodiment, FIG. 1 shows an autonomous vehicle 10. In an exemplary embodiment, the autonomous vehicle 10 is a so-called Level Four or Level Five automation system. It is to be understood, however, that the system and methods disclosed herein can also be used with an autonomous vehicle offering any of the autonomous levels of Levels One through Five. In various embodiments, the vehicle can be a semi-autonomous vehicle or a fully autonomous vehicle. A Level Four system indicates “high automation,” referring to the driving mode-specific performance by an automated driving system of all aspects of the dynamic driving task, even if a human driver does not respond appropriately to a request to intervene. A Level Five system indicates “full automation,” referring to the full-time performance by an automated driving system of all aspects of the dynamic driving task under all roadway and environmental conditions that can be managed by a human driver.

The autonomous vehicle 10 generally includes at least a navigation system 20, a propulsion system 22, a transmission system 24, a steering system 26, a brake system 28, a sensor system 30, an actuator system 32, and a controller 34. The navigation system 20 determines a road-level route plan for automated driving of the autonomous vehicle 10. The propulsion system 22 provides power for creating a motive force for the autonomous vehicle 10 and can, in various embodiments, include an internal combustion engine, an electric machine such as a traction motor, and/or a fuel cell propulsion system. The transmission system 24 is configured to transmit power from the propulsion system 22 to two or more wheels 16 of the autonomous vehicle 10 according to selectable speed ratios. The steering system 26 influences a position of the two or more wheels 16. While depicted as including a steering wheel 27 for illustrative purposes, in some embodiments contemplated within the scope of the present disclosure, the steering system 26 may not include a steering wheel 27. The brake system 28 is configured to provide braking torque to the two or more wheels 16. In an embodiment, the autonomous vehicle 10 can be an electrical vehicle in various embodiments. In other embodiments, the autonomous vehicle 10 can include an autonomous vessel, a plane, or a machine used for agricultural purposes.

The sensor system 30 includes a radar system 40 that senses objects in an exterior environment of the autonomous vehicle 10 and determines various parameters of the objects useful in locating the position and relative velocities of various remote vehicles in the environment of the autonomous vehicle. Such parameters can be provided to the controller 34. In operation, the transmitter 42 of the radar system 40 sends out a radio frequency (RF) reference signal 48 that is reflected back at the autonomous vehicle 10 by one or more objects 50 in the field of view of the radar system 40 as one or more echo signals 52, which are reflected signals received at receiver 44. The one or more echo signals 52 can be used to determine various parameters of the one or more objects 50, such as a range of the object, Doppler frequency or relative radial velocity of the object, and azimuth, etc. The sensor system 30 includes additional sensors, such as digital cameras, for identifying road features, Lidar, etc.

A driver monitoring system 46 monitors a driver, user, or passenger of the autonomous vehicle 10. The driver monitoring system 46 records actions taken by the user, a direction of attention of the user (by observing eye location or movement), a facial expression of the user, etc., in order to determine a reaction of the user to vehicle movement. In other embodiments, the autonomous vehicle can be without a driver monitoring system 46. The use of a driver monitoring system is not meant to be a limitation on the invention.

The controller 34 builds a trajectory for the autonomous vehicle 10 based on the output of sensor system 30. The controller 34 can provide the trajectory to the actuator system 32 to control the propulsion system 22, transmission system 24, steering system 26, and/or brake system 28 in order to navigate the autonomous vehicle 10 with respect to the object 50.

The controller 34 includes a processor 36 and a computer readable storage device or computer readable storage medium 38. The storage medium includes programs or instructions 39 that, when executed by the processor 36, perform the methods disclosed herein for operating the autonomous vehicle 10 based on sensor system outputs. The computer readable storage medium 38 may further include programs or instructions 39 that when executed by the processor 36, provide information that can be used to allow the autonomous vehicle to navigate through traffic in a manner that reduces a level of uncertainty, surprise, or anxiety in the passenger or other vehicle user.

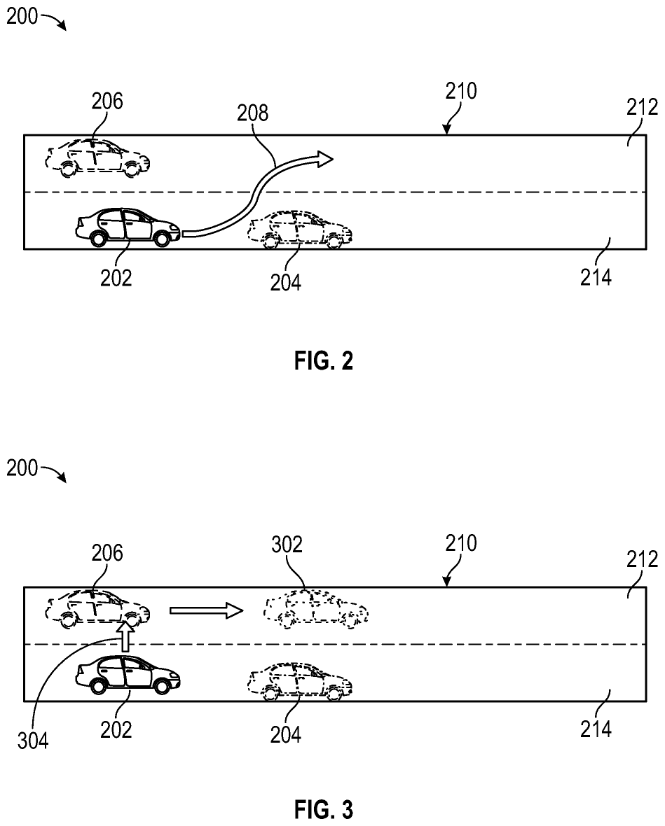

FIG. 2 shows a traffic scenario 200 for illustrating operation of the system disclosed herein. In the traffic scenario 200, the host vehicle 202 (i.e., the autonomous vehicle 10) is moving along a roadway 210 which has a left lane 212 and a right lane 214. The host vehicle 202 is currently moving in the right lane 214 and is behind a first target vehicle 204. A second target vehicle 206 is currently in the left lane 212 near the host vehicle 202 and is moving faster than the first target vehicle 204. The host vehicle 202 plans to move ahead of the first target vehicle 204 by performing a first action 208. The first action 208 includes switching to the left lane 212 ahead of the second target vehicle 206, accelerating past the first target vehicle 204 and switching back to the right lane 214.

FIG. 3 shows the traffic scenario 200 of FIG. 2 and a second action 304 that can be performed by the host vehicle 202 in this traffic scenario to achieve the same goal of passing the first target vehicle 204. The second action 304 includes waiting for the second target vehicle 206 to advance to a location 302 further down the roadway 210 than the host vehicle 202 and then switching to the left lane 212 thereby placing the host vehicle 202 behind the second target vehicle 206. The second action 304 is indicated by an arrow in FIG. 3. Once the second target vehicle 206 moves ahead of the first target vehicle 204 by a sufficient distance, the host vehicle 202 can move ahead of the first target vehicle 204 and switch back to the right lane 214.

With respect to the traffic scenario shown in FIGS. 2 and 3, the host vehicle 202 can select either to perform the first action 208 or the second action 304. When the host vehicle 202 performs the first action 208, there can be a high level of uncertainty or anxiety on the part of the passenger. On the other hand, the host vehicle 202 performing the second action 304 can result in less uncertainty or anxiety on the part of the passenger. For example, the second action 304 moves the host vehicle 202 behind the second target vehicle 206, thereby allowing the host vehicle 202 to control the space between itself and the second target vehicle 206. While both actions may be equally viable from the user's perspective, the first action 208 might have more uncertainty associated with it than the second action 304. A more aggressive driver may wish to select the first action 208, while a more conservative driver may prefer to perform the second action 304 due to its reduced levels of uncertainty and anxiety.

The methods disclosed herein determine a difference between a possible action that a vehicle plans to take in a given traffic scenario and a possible action that a human would take in the same traffic scenario or that a human would expect the vehicle to take in the traffic scenario. A difference between these actions can cause surprise or uncertainty in the human. In one embodiment, the difference between either the actions or in driver expectations can be used to make an adjustment to the vehicles planned action that mitigates the difference. Alternatively, the difference can be used to provide a notification or explanation to the user about the reasons the vehicle behaves as it does.

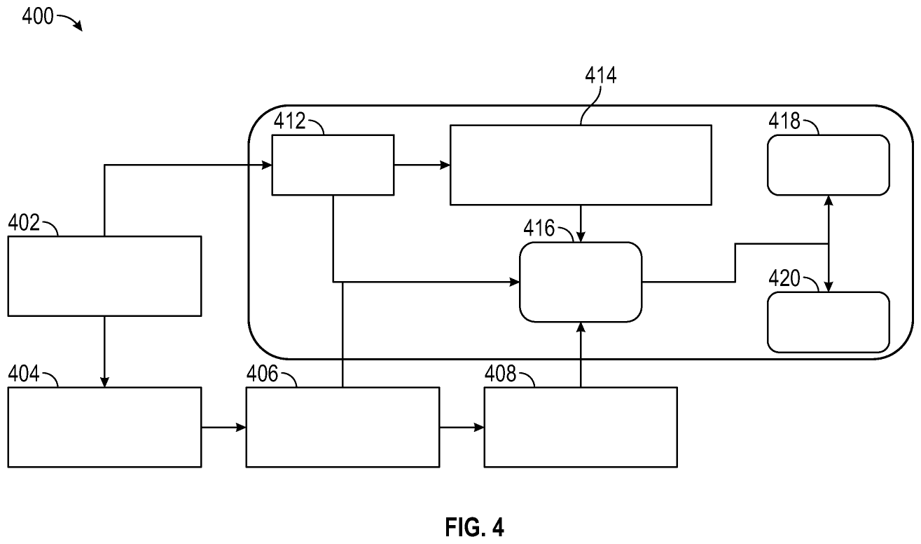

FIG. 4 shows a flowchart 400 illustrating a process of determining a difference between a human expectation of the vehicle's response to a traffic scenario and the vehicle's actual response to the traffic scenario. The traffic scenario 402 and any other information is supplied as input into a control planner 404 operating at a processor of the host vehicle 202. For the vehicle in a current state (represented as s), the control planner 404 selects a machine-selected action 406 (or ‘optimal action’ represented as a*) from a plurality of possible actions. The actual next state 408 (represented as s′) is attained by the host vehicle 202 by performing the machine-selected action 406. For example, in the traffic scenario of FIGS. 2 and 3, the machine-selected action 406 taken by the host vehicle 202 can be to pass in the first target vehicle 204 immediately (i.e., the first action 208) which results in the actual next state 408 of switching to the left lane 212.

The traffic scenario 402 is sent to a user model 412 to generate a user-expected action. The user model 412 is a model of a user's probable actions for a given state of the host vehicle 202 and a model of a user's expectations of the next state of the host vehicle 202 given a selected action. The model of the user's probable action can be a probability distribution over a domain of possible actions for the traffic scenario 402. Similarly, the model of the user's expectations of the next state of the vehicle given a selected action can be a probability distribution.

The traffic scenario 402 is input to the user model 412 to select a user-expected action 414 (represented as a) to the traffic scenario and to output a user-expected next state (represented as s″). For the illustrative traffic scenario of FIGS. 2 and 3, the user-expected action 414 can be to wait for the second target vehicle 206 to pass (i.e., the second action 304) which results in a user-expected next state that the host vehicle remains in the current lane (i.e., the right lane).

A gap detector 416 receives the optimal action (a*) selected by the vehicle and the actual next state s′ of the vehicle given the optimal action. The gap detector 416 also receives the user-expected action a selected using the user model and the user-expected next state s″. The gap detector 416 determines whether a gap is significant (box 418) or whether a gap is not significant (box 420). A gap can refer to a difference between a user-expected action (or its distribution) and a machine-selected action, or a difference between the actual next state and a user-expected next state (or its distribution), or a combination thereof. The gap detector 416 compares the difference to a threshold. When the difference meets a criterion or is greater than the threshold, the method returns that the gap is true (e.g., a significant difference between the expected action or state and the action selected by the vehicle and resulting state). When the gap is less than the threshold, the method returns that the gap is false or that there is little or no significant difference between the expected action or state and the action selected by the vehicle and resulting state.

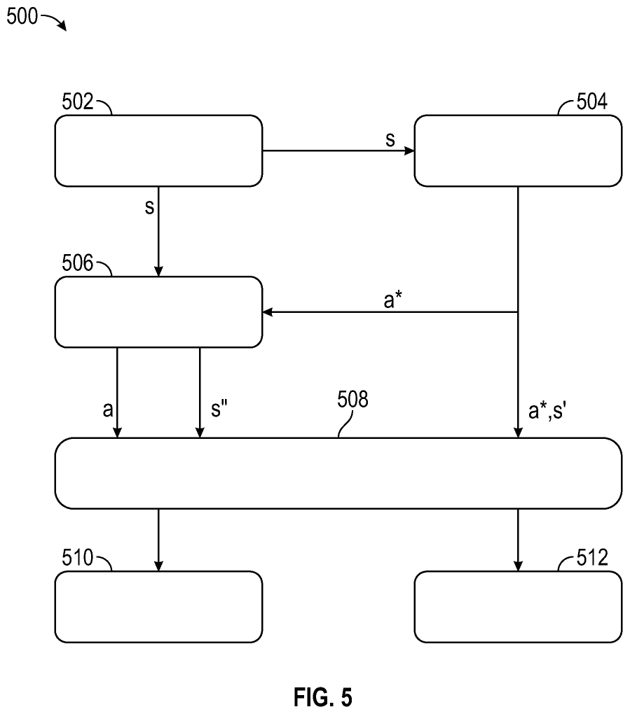

FIG. 5 shows a schematic diagram 500 of a system that determines a difference between machine behavior and human behavior with respect to a traffic scenario. Box 502 includes a current state (s) of the vehicle. Box 504 is a vehicle model that is used for selecting a machine-selected action. Box 506 is a user model that models human behavior and expectation with respect to a traffic scenario. The user model can be used to determine a user-expected action for the traffic scenario and a user-expected next state. The current state (s) is input to the vehicle model. At box 504, the vehicle model outputs the machine-selected action (a*) for the current state and the actual next state (s′) based on the vehicle-selected action (a*). The current state (s) and the machine-selected action (a*) are also provided to the user model. In box 506, the user model outputs a user-expected action (a) based on the current state (s) and a user-expected next state (s″) based on the machine-selected action (a*), and current state (s).

Box 508 includes a gap detector. The machine-selected action (a*) and the actual next state (s′) are output from the vehicle model to the gap detector. Also, the user-expected action (a) and the user-expected next state (s″) are output to the gap detector from the user model.

In box 508, the gap detector determines or estimates a gap or difference between the actions and between the states. There are two types of gaps: gaps in actions and gaps in states. Each type of gap can be determined either by comparing the probability distribution from the user model to the machine-selected action or actual next state, or by comparing the expected action or expected next state (according to the user model) to the machine-selected action or actual next state. A gap exists if any one of these methods indicates the existence of the gap. For each method, the gap detector compares the gap to a threshold value to determine whether, in one case, the vehicle behavior is significantly different than a user-expected behavior to cause alarm to the user (TRUE, box 510) or, in another case, the vehicle behavior is close enough to the user-expected behavior that the user has a level of certainty regarding the vehicle's behavior. (FALSE, box 512)

The user model of box 502 can be created using at least two methods. A first method includes testing of subjects by exposing them to simulations and collecting their responses. A second method includes solving a constrained Markov Decision Process with a different set of hyperparameters for different scenarios and then running the user model through test subjects to find a suitable range for the hyperparameters that balances an expected reward vs. uncertainty for the test subjects, at each scenario.

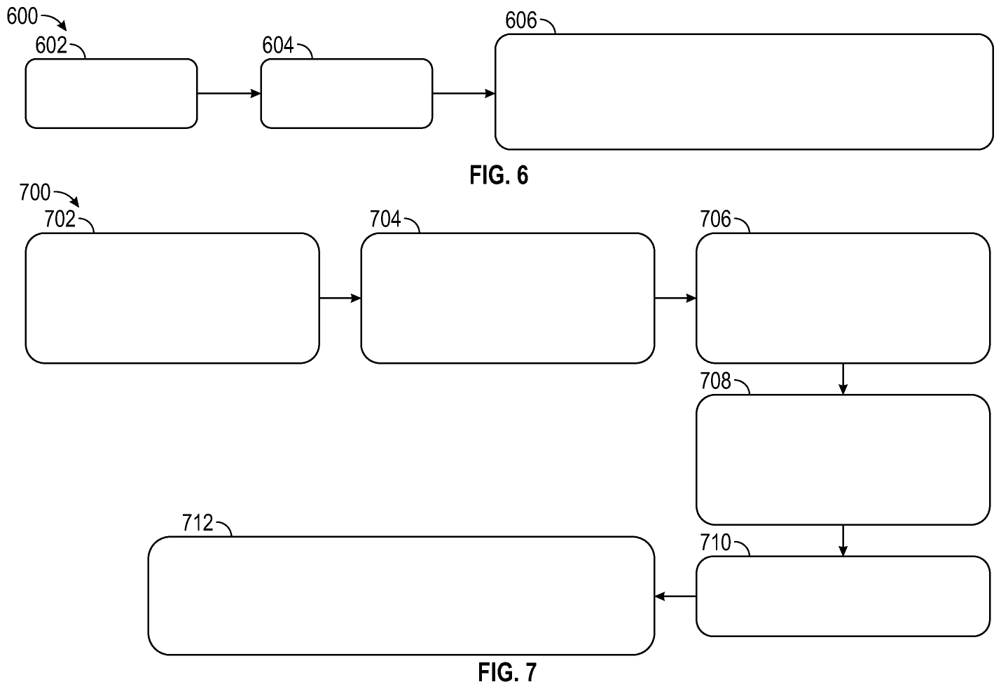

FIG. 6 shows a flowchart 600 of a first method for determining the user model of box 506 in FIG. 5 using a non-information theoretic model, in an illustrative embodiment. In box 602, a user study is performed. The user study can include, for example, posing questions to test subjects concerning different driving actions or maneuvers based on experience or after viewing a simulation. In box 604, user data is collected from the user study indicating the response of the test subjects. In box 606, the user model is generated from the data. The user model can include a user action probability model that gives a probability distribution over possible actions and an expected state probability model that gives a probability distribution with respect to various expected outcomes.

The user action probability model can be a probabilistic model or probability distribution indicating a probability of the user for taking an action in a given traffic scenario. Similarly, the expected state probability model can be a probabilistic model or probability distribution indicating a probability that a user expects to be in a next state of the vehicle given an action.

In one embodiment, the user study includes showing users a movie of a driving maneuver in different driving scenarios. Users then provide answers to questions. In one example, the users are asked to express their levels of trust and satisfaction during the maneuvers presented to them. In one embodiment, a trust and satisfaction interview can be used such as discussed in XAI metrics (“Metrics for Explainable AI: Challenges and Prospects”, Robert R. Hoffman, Shane T. Mueller, Gary Klein, Jordan Litman (2019)). In another example, users can be asked to specify a next expected action in a certain scenario given that a vehicle performs a certain maneuver or action.

The user action probability model or P_u(a|s) gives a probability that an action ‘a’ will be preferred by a user (indicated by subscript ‘u’) when the vehicle is in state ‘s’. The user actions can be determined by polling the test subjects. The user action probability model is computed based on votes from the test subjects or the one with maximal average trust and satisfaction, as shown in Eq. (1):

$${P}_{u ( a \vert s )} = \frac{{\sum }_{i = 1}^{N} Vote ( a , i )}{N} \qquad Eq . ( 1 )$$

where N is the number of test subjects polled, i is the index of the test subject, vote(a,i)=1 if the i^{th} test subject chooses action ‘a’ when the vehicle is in state ‘s’, otherwise, vote(a,i)=0.

The user model (both the user action probability model and the expected state probability model) can be maintained by repeating the user study at periodic intervals. Also, the test subjects for the user study can be selected so as to personalize the user model to a specific user or set of users. For example, the probability values of the user model can be filtered by age group, gender or any other characteristic that might affect the expectation of the user. The user study can also be applied by observing a user or passenger during a driving experience.

The driver monitoring system 46 can be used to detect a reaction of the passenger in order to gauge a level of comfort of the user with the vehicle's action. An example of a passenger's reaction includes the passenger taking manual control of the vehicle to disengage the vehicle from automated driving. The vehicle can record that the passenger has taken control, thereby determining that the passenger does not trust the action of the vehicle. The user can also provide direct feedback to the vehicle by pushing a button or other input device. The driver monitoring system 46 can also recognize facial gestures to record a passenger's satisfaction or discontent with the machine-selected action.

FIG. 7 shows a flowchart 700 of a second method for determining the user model of box 506 in FIG. 5 using an information theoretic model, in an illustrative embodiment. In box 702, a Markov Decision Process (MDP) is adjusted with the observations and/or rewards the user is aware of as the user experiences the vehicle behavior. In box 704, a free energy model (e.g., an extension of the free energy model as given by Tishby and Polani, “The Information Theory of Decision and Action” Perception-Action Cycle: Models, Architectures, and Hardware (pp. 601-636) Chapter 19, 2011) is run for different sets of hyperparameters resulting in a policy for each set of hyperparameters. In various embodiment, these hyperparameters can be a Lagrange multiplier β for a constraint vector of the MDP and/or a discounting factor γ. In box 706, a scenario is created for each of the policies. In box 708, the scenarios are presented to test subjects in a user study and the test subjects are asked questions to determine a level of trust and/or satisfaction for each of the hyperparameters. In box 710, data is collected from the users. In box 712, the user model is created by finding a range for the values of the hyperparameters that balances and expected reward with an uncertainty experienced by the user. The determined range of the hyperparameters indicates a range of actions for which a human will experience a feeling of trust and satisfaction with the vehicle behavior.

The free energy model of box 704 solves an optimization problem as shown in Eq. (1):

$${max}_{π} {V}^{π} ( {s}_{0} ) such that information \leq C \qquad ( 1 )$$

where V is the expected reward for policy π. The expected reward is as shown in Eq. (2):

V^{π}(s)=Σ_{a∈A}π(a|s)·Σ_{s′∈S}Pr(s′|s,a)[R(s,z)+V^{π}(s′)] (2)

The information in Eq. (1) includes an uncertainty H and a divergence P. A constraint equation for the uncertainty H for a given policy π is given in Eq. (3):

H^{π}(s)=E{−log Pr(s′|s,a)+H^{π}(s′)}≤C₁ (3)

and a constraint for a KL-divergence of the policy from a uniform distribution is given in Eq. (4):

$${P}^{π} ( s ) = {E}_{Pr ( {s}^{′} , a \vert s )} \{ log \frac{π ( a \vert s )}{π ( a )} + {P}^{π} ( {s}^{′} ) \} \leq {C}_{2} \qquad ( 4 )$$

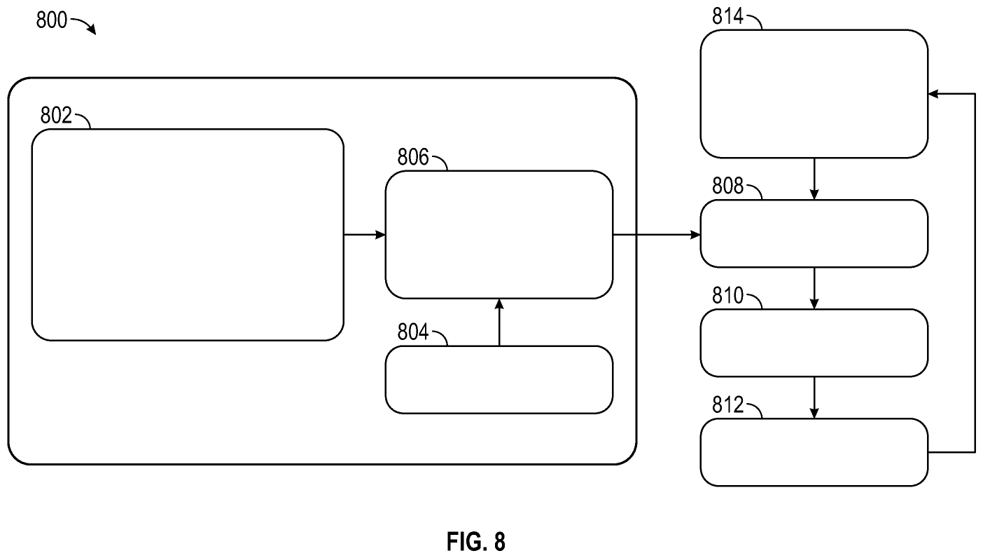

FIG. 8 shows a flowchart 800 of a method for maintaining or adjusting the user model via the information theoretic model created in FIG. 7. In particular, the hyper-parameters can be adjusted to fit the temperament of the user. For example, Lagrange multiplier β can be decreased to allow for more aggressive driving and can be increased to enforce more conservative driving.

In box 802, the driver monitoring system 46 obtains measurements that indicate where the driver or passenger is looking. The measurements allow knowledge of what information the passenger is or is not aware of. In box 804, a system transition model used by the vehicle is provided. In box 806, the system transition model is adjusted using the information of the user's awareness, resulting in an adjusted state and transition model (adjustments to the MDP). In box 808, the free energy model is applied to the adjusted MDP to create a user model policy, shown in box 810. In box 812, the passenger is monitored to identify any intervening actions by the passenger. In box 814, the hyperparameters of the user model are adjusted based on the passenger reactions. The original set of hyperparameters is the set determined during the user model creation process discussed with respect to FIG. 7. The adjusted user model is then sent to box 808 in which the free energy model can run again to refine the user model policy.

Different user model policies can be calculated off-line for different values of parameters. A precalculated user model policy can be applied to a particular user's behavior (i.e., more aggressive, more conservative) by applying a suitable set of hyperparameters, thereby tailoring the user model to the particular user. The tailored user model can be created either offline or online.

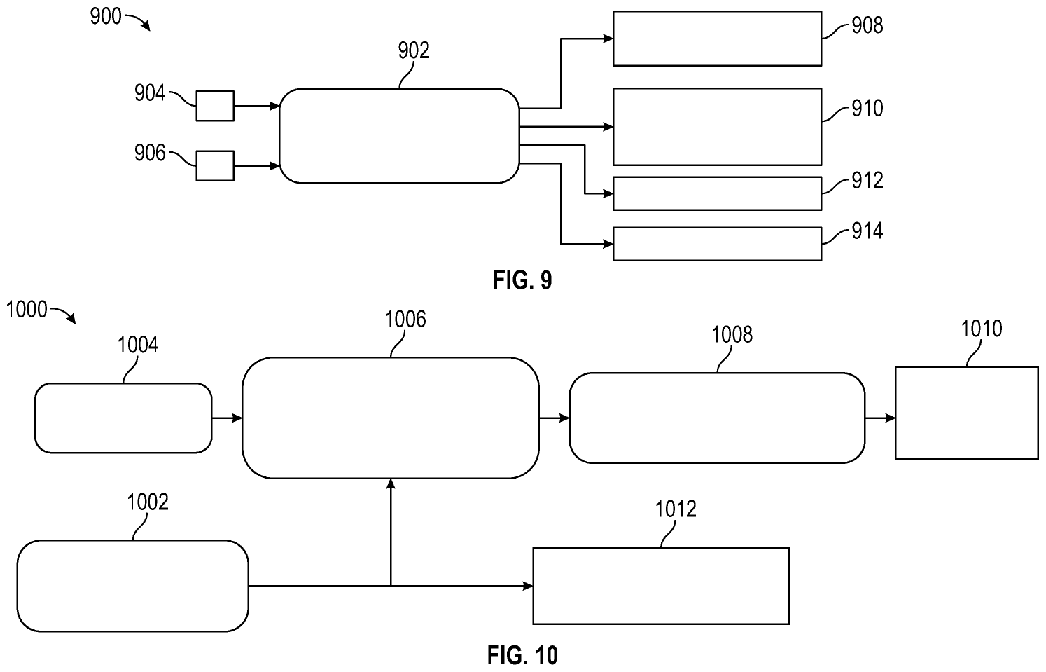

FIG. 9 shows a flowchart 900 of a method for using the user model to generate actions and next states via the non-information theoretic model of FIG. 6. The user model 902 receives input in the form of the current state s (box 904) and the optimal action a* (box 906). In response to the current state s, the user model 902 outputs the user-expected action a (box 908). In response to the optimal action a*, the user model 902 outputs the user-expected next state s″ (box 910). The user model 902 will also output the user action probability distribution P_u(a|s) (box 912) and the expected state probability distribution P_u(s″|s,a*) (box 914) based for the optimal action.

When a new user faces some current state s, the user model can be applied using various different methods. The current state s is compared to various stored states to determine a set of closest or most similar stored sates sᵢ. An expected action is determined for each state sᵢ. In a first implementation, a vote is made of the expected actions and the expected action with the most votes is selected. In a second implementation, an expected trust and satisfaction for the current state s is determined as the average values of trust and satisfaction for all the similar states sᵢ. The action associated with the state having the maximal trust and satisfaction is selected as the expected action. In a third implementation, the next action is selected using models for users that are similar to the new user. In a fourth implementation, a classifier is trained with data and used to predict an action and next state for a given traffic scenario and current state. The user expectation for an action is the one that maximized a predicted trust and satisfaction, as shown in Eq. (5):

$${a}_{user} = {argmax}_{a} \{ expected trust ( a ) + expected satisfaction ( a ) \} \qquad ( 5 )$$

FIG. 10 shows a flowchart 1000 of a method for using the information theoretic model to generate actions and next states. In box 1002, a state transition model is obtained and adjusted for the user. The state transition model can be constructed from an autonomous system transition model and any input from the driver monitoring system 46 that provides an indication of information available (or not available) to the user. The hyperparameter β and γ (box 1004) are combined with the state transition model to form the information theoretic model at box 1006, which is used to output a policy. In box 1008, the policy is applied to the current state s to output a user-expected action (a) and/or a user action probability distribution P_u(a|s). (box 1010). The state transition model in box 1002 is also used to output a user-expected state s″ and/or the expected state probability distribution P_u(s″|s,a) (box 1012).

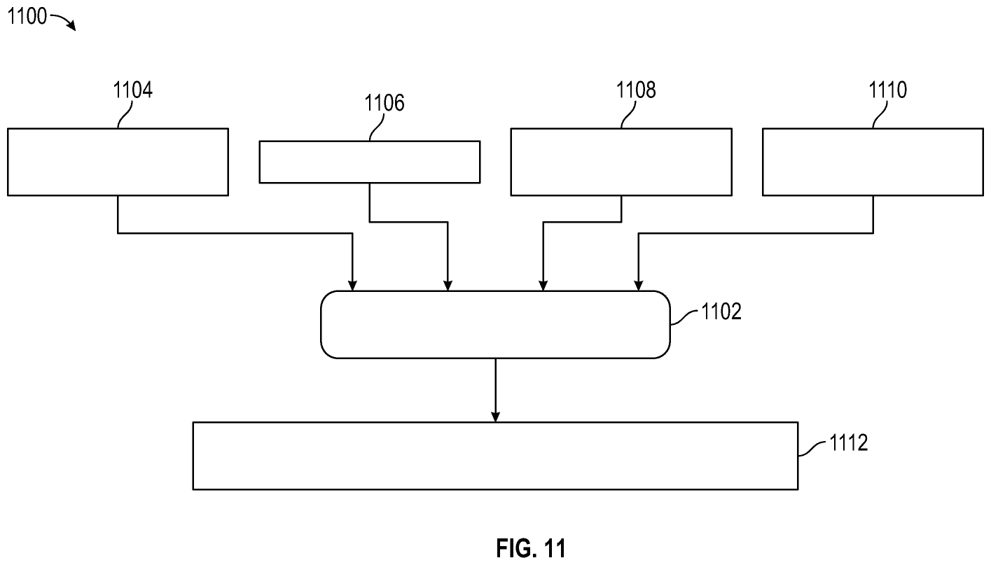

FIG. 11 shows a flowchart 1100 illustrating operation of the machine system of box 504 for selecting an optimal action for the vehicle. In an embodiment, the machine system 1102 runs a value iteration program that finds an action that maximizes a reward for the next state. The machine system 1102 receives the state (s) of the vehicle (box 1104), a set of possible actions A (box 1106), a machine transition model P(s′|s,a) (box 1108) and a machine reward function R(s,a,s′) (box 1110). The machine system 1102 runs a value algorithm (box 1112) to determine a policy that maximizes the reward for an action, as shown in Eq. (6):

$$π ( s ) = {argmax}_{a} R ( s , a , {s}^{′} ) \qquad ( 6 )$$

Thus, the policy π performs the action (a) that maximizes the reward R.

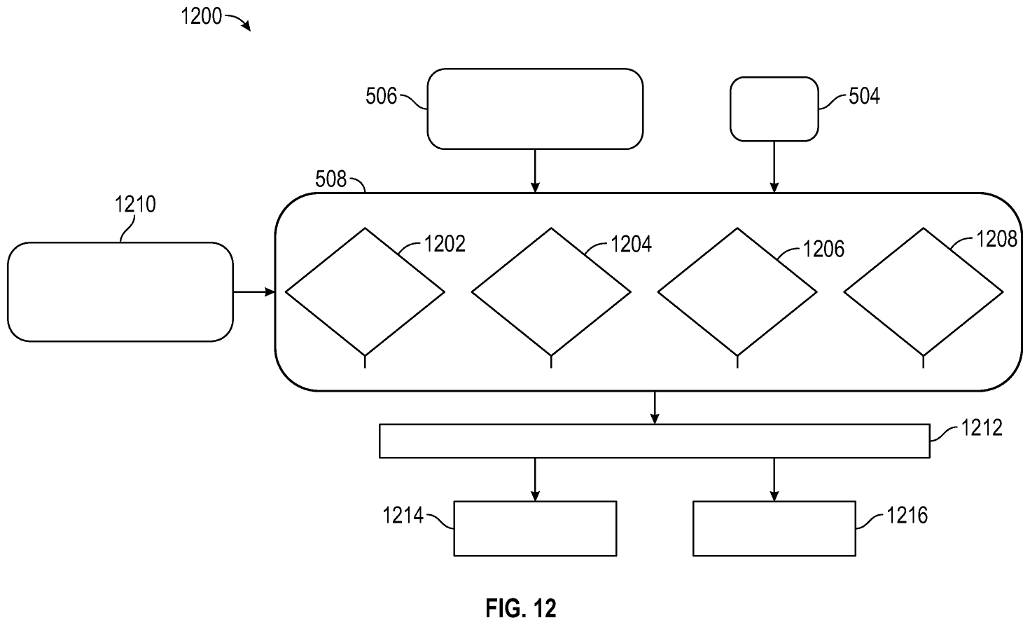

FIG. 12 shows a flowchart 1200 illustrating operation of the gap detector of box 508 of FIG. 5. The gap detector receives the user-expected action (a) and the user-expected next state (s″) from the user model (box 506). The gap detector also receives the optimal action (a*) and the actual next state (s′) from the machine model (box 504). The gap detector computes the differences between these quantities and compares the quantities to various threshold.

The gap detector can perform at least one of four different comparisons. In box 1202, a comparison is made between action probabilities. In box 1204, a comparison is made between expected next state probabilities. In box 1206, a comparison is made between different action selections (i.e., between a user model expected action and a machine selected action). In box 1208, a comparison is made between different next states (i.e., between a user-expected next state based on the optimal action selected by the vehicle and the actual next state). Each comparison can be compared to a respective threshold, which is supplied to the gap detector at box 1210. The threshold helps to determine if the difference between the compared actions or states is actually considered enough to be of concern to a user.

In box 1202, a difference is determined between the user's action probability distributions and the systems chosen action. An action threshold θₐ>=0 is assumed.

In a first implementation of box 1202, the probability distribution P_u(a*|s) is compared to a maximum value of P_u(a|s). If the maximizing action is both sufficiently different from the optimal action and the difference in probabilities is greater than the threshold θₐ, a TRUE value is returned. Otherwise, FALSE is returned.

In a second implementation of box 1202, a maximum value of P_u(a|s) is found over all actions a that are within a selected neighborhood of the optimal action a*. This neighborhood can be determined as a semantic distance or other measure of subjective perception that tells that a user does not see any difference between these actions (if chosen). The maximizing value is then marked as a**. The probability P_u(a**|s) is then compared to the maximizing value of P_u(a|s) over all possible actions. If the maximizing action is sufficiently different from a** and the difference in probabilities is greater than the threshold θₐ, then TRUE is returned. Otherwise, FALSE is returned.

In box 1204, a gap is determined between expected next states. Assuming a probability distribution P_u(s″|s,a*) for the user model and the actual next state s′, two methods can be used to calculate the gap. In a first method, the maximizing state of P_u(s″|s, a*) is found and its probability is compared with that of P_u(s′|s, a*). If the difference is greater than the threshold and the maximizing state is sufficiently different from s′, TRUE is returned, otherwise, FALSE is returned. In a second method, a maximum value of P_u(s″|s, a*) is found over all states s″ that are within a selected neighborhood of the actual state s′. The maximizing state is denoted as s*. P_u(s*|s,a*) is compared to the maximum over all possible state of P_u(s″|s,a*). If this difference is greater than a threshold, return TRUE. Otherwise, return FALSE.

In box 1206, a difference is determined between selected actions. An action threshold θₐ>=0 is assumed. In a first implementation of box 1206, when the action threshold θₐ=0, if a* and a are different, then TRUE is returned. Otherwise, FALSE is returned. A second implementation of box 1206 includes a personalized or human-centered approach by determining whether a different action is considered distinguishable to a human. For example, reducing a vehicle's speed by 1-2 mph might be negligible while driving on a highway. If the difference is distinguishable, TRUE is returned. Otherwise, FALSE is returned.

In box 1208, a gap is determined between user expected next state (s″) and actual next state (s′). An expectation threshold θₛ>=0 is assumed. In a first implementation, when the threshold θₛ=0, if the actual next state is s′ and the user expected s″ based on action a* are not the same, then TRUE is returned. Otherwise, FALSE is returned. A second implementation of box 1208 includes a personalized or human-centered approach by determining whether a different state is considered distinguishable to a human.

A class of states is defined. The class is given by a set of similar states. A state is similar to another state when, for example, all of the parameter values are within a selected distance θₛ of each other. If the actual next state s′ and user expected next state s″ do not belong to the same class of states, the TRUE is returned. Otherwise, FALSE is returned.

In box 1212, an OR function is applied to the values (TRUE, FALSE) of each of the output from boxes 1202, 1204, 1206 and 1208 to return a final gap determination value. The results of the OR function returns either TRUE (box 1214) or FALSE (box 1216).

Once the results of the comparison are generated, various signals can be output. In one embodiment, the output signal includes that the action can either be used at the vehicle or an adjustment can be made to the machine selected action. In another embodiment, the signal provides an explanation to the user to inform the user about the differences between the user's expectations and the applied action. The signal can also provide that the vehicle adjusts the machine-selected action to correspond to a user-expected action. Alternatively, the signal can cause the vehicle to transfer control over to the user. The signal can cause the difference to be provided to a traffic controller to allow the traffic controller to make suitable adjustments.

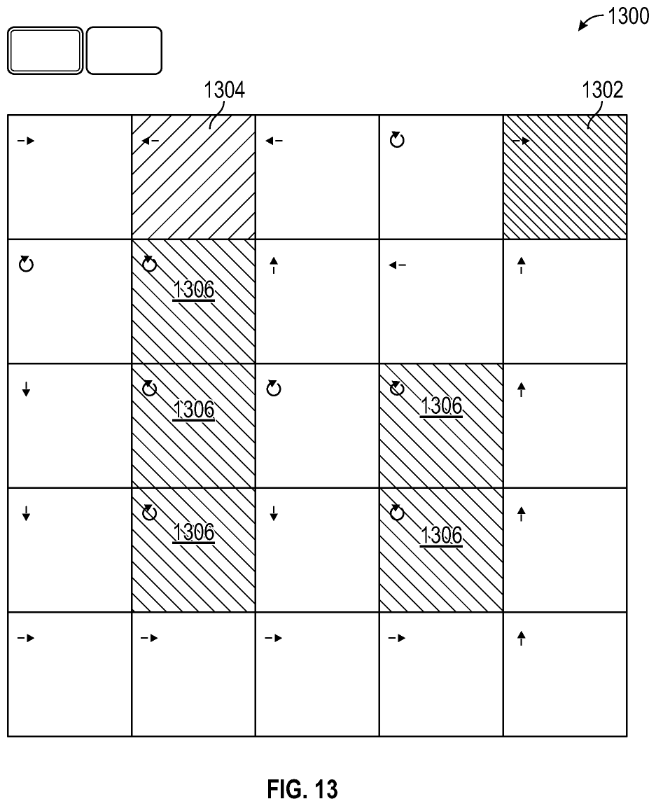

FIG. 13 shows a gridworld environment 1300 suitable for use in creating an information-theoretic model, in an illustrative embodiment. The gridworld includes a grid with different probabilities and rewards assigned to each cell of the grid. The environment includes a first vehicle 1302 (i.e., host vehicle 202) and an additional entity or second vehicle 1304 (i.e., first target vehicle 204). The location of the second vehicle 1304 is observable. The transition probabilities are known. A collision between the vehicles is given a high penalty. The environment includes constraints such that the goals of the two vehicles are different. Cells 1306 represents walls or unattainable cells for the vehicle. The second vehicle 1304 can have any given policy and is known to the first vehicle 1302. The gridworld environment is used to calculate constrained policies of the first vehicle 1302.

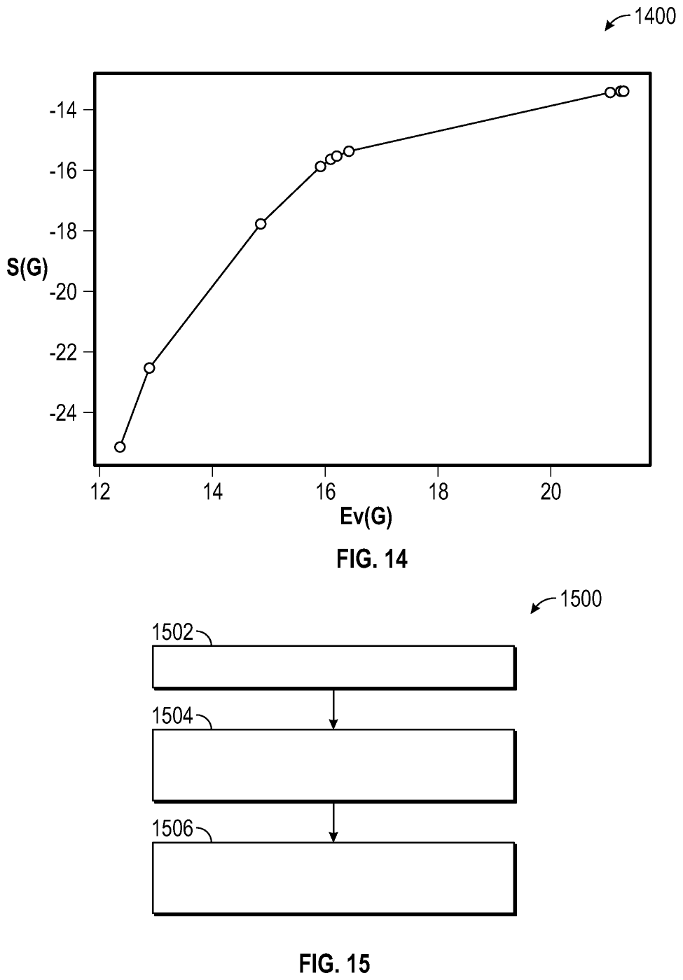

FIG. 14 shows a graph 1400 of expected value vs. entropy S(G) for the gridworld environment of FIG. 13. The entropy is along the x-axis and the expected value EV(G) is along the y-axis. The hyperparameter β is a slope of the graph at a given entropy value or expected value.

FIG. 15 shows a flowchart 1500 for a method of adjusting the state transition model to obtain a smoothed transition model for a particular user. In box 1502, the baseline transition model is obtained from the automated machine. In box 1504, information is obtained about what is known and what is not known to the user. The driver monitoring system 46 can be used to obtain this information. For example, the driver monitoring system 46 can identify where the driver is looking. Assuming the driver is looking to the right, information from the left side of the vehicle is assumed to be unavailable to the driver. In box 1506, the baseline transition model is smoothed or modified based on the unavailable information.

For example, the current state s of the machine and actual next state s′ are represented by vectors shown in Eq. (7a) and Eq. (7b), respectively:

s=(x₁,x₂, . . . ,xₖ) (7a)

s′=(x₁′,x₂′, . . . ,xₖ) (7b)

The coordinates in Eq. (8) are considered to be not available to the user:

(xₗ,xₗ₊₁, . . . ,xₖ) (8)

The smoothed transition probability model is given as shown in Eq. (9)

$$Pr ( {\hat{s}}^{′} \vert a , \hat{s} ) = \frac{{\sum }_{( {{x}^{′}}_{{l}^{′}} , … {{x}^{′}}_{k} )} {\sum }_{( {x}_{l} , … {x}_{k} )} Pr ( {s}^{′} \vert s , a ) \cdot Pr ( s , a )}{{\sum }_{( {x}_{l} , … {x}_{k} )} Pr ( s , a )} \qquad ( 9 )$$

where the summations in the numerator are over the unavailable coordinates of the current state and next state of Eqs. (7a) and (7b) and where:

ŝ=(x₁,x₁, . . . ,xᵢ₋₁) (10)

represents the states available in the user model (composed of the available coordinates).

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating a vehicle, comprising:
determining a machine-selected action for the vehicle in a current state and an actual next state for the vehicle resulting from the machine-selected action;
determining, using a user model, a user-expected action for the vehicle in the current state and a user-expected next state for the vehicle resulting from applying the machine-selected action;
determining a gap value based on at least one of the user-expected action, the machine-selected action, the actual next state and the user-expected next state; and
outputting a signal when the gap value meets a threshold.

2. The method of claim 1, wherein the user model includes a first model characterizing the user-expected action for the vehicle in the current state and a second model characterizing the user-expected next state.

3. The method of claim 1, wherein determining the gap value further comprises at least one of: (i) determining a difference between the user-expected action and the machine-selected action; (ii) determining the difference between the user-expected next state the actual next state; (iii) determining the difference between a distribution over the user-expected action and the machine-selected action; and (iv) determining the difference between the distribution over the user-expected next state the actual next state.

4. The method of claim 1, further comprising creating the user model by at least one of: (i) polling a reaction of a test subject to a traffic scenario; and (ii) applying constraints on a Markov Decision Process to create a free energy model having one or more hyperparameters and polling the reaction of the test subject to determine the values of the one or more hyperparameters.

5. The method of claim 4, further comprising adjusting the value of the one or more hyperparameter of the user model to fit a behavior of a selected user.

6. The method of claim 1, wherein outputting the signal further comprises at least one of: (i) providing an explanation to a user about the gap value; (ii) adjusting the machine-selected action to correspond to the user-expected action; (iii) transferring control of the vehicle to the user; and (iv) providing the gap value to a traffic controller.

7. The method of claim 1, further comprising adjusting the user model to suit a knowledge of a user.

8. A system for operating a vehicle, comprising:
a processor configured to:
determine a machine-selected action for the vehicle in a current state and an actual next state for the vehicle resulting from the machine-selected action;
determine, using a user model, a user-expected action for the vehicle in the current state and a user-expected next state for the vehicle resulting from applying the machine-selected action;
determine a gap value based on at least one of the user-expected action, the machine-selected action, the actual next state and the user-expected next state; and
output a signal when the gap value meets a threshold.

9. The system of claim 8, wherein the user model includes a first model characterizing the user-expected action for the vehicle in the current state and a second model characterizing the user-expected next state.

10. The system of claim 8, wherein the processor is further configured to determine the gap value by determining at least one of: (i) a difference between the user-expected action and the machine-selected action; (ii) the difference between the user-expected next state the actual next state; (iii) the difference between a distribution over the user-expected action and the machine-selected action; and (iv) the difference between the distribution over the user-expected next state the actual next state.

11. The system of claim 8, wherein the processor is further configured to create the user model by at least one of: (i) polling a reaction of a test subject to a traffic scenario; and (ii) applying constraints on a Markov Decision Process to create a free energy model having one or more hyperparameters and polling the reaction of the test subject to determine the values of the one or more hyperparameters.

12. The system of claim 11, wherein the processor is further configured to adjust the value of the one or more hyperparameters of the user model to fit a behavior of a selected user.

13. The system of claim 8, wherein the processor is further configured to output the signal by performing at least one of: (i) providing an explanation to a user about the gap value; (ii) adjusting the machine-selected action to correspond to the user-expected action; (iii) transferring control of the vehicle to the user; and (iv) providing the gap value to a traffic controller.

14. The system of claim 8, wherein the processor is further configured to adjust the user model to suit a knowledge of a user.

15. A vehicle, comprising:
a processor configured to:
determine a machine-selected action for the vehicle in a current state and an actual next state for the vehicle resulting from the machine-selected action;
determine, using a user model, a user-expected action for the vehicle in the current state and a user-expected next state for the vehicle resulting from applying the machine-selected action;
determine a gap value based on at least one of the user-expected action, the machine-selected action, the actual next state and the user-expected next state; and
output a signal when the gap value meets a threshold.

16. The vehicle of claim 15, wherein the user model includes a first model characterizing the user-expected action for the vehicle in the current state and a second model characterizing the user-expected next state.

17. The vehicle of claim 15, wherein the processor is further configured to determine the gap value by determining at least one of: (i) a difference between the user-expected action and the machine-selected action; (ii) the difference between the user-expected next state the actual next state; (iii) the difference between a distribution over the user-expected action and the machine-selected action; and (iv) the difference between the distribution over the user-expected next state the actual next state.

18. The vehicle of claim 15, wherein the processor is further configured to create the user model by at least one of: (i) polling a reaction of a test subject to a traffic scenario; and (ii) applying constraints on a Markov Decision Process to create a free energy model having one or more hyperparameters and polling the reaction of the test subject to determine the values of the one or more hyperparameters.

19. The vehicle of claim 15, wherein the processor is further configured to output the signal to perform at least one of: (i) providing an explanation to a user about the gap value; (ii) adjusting the machine-selected action to correspond to a user-expected action; (iii) transferring control of the vehicle to the user; and (iv) providing the gap value to a traffic controller.

20. The vehicle of claim 15, wherein the processor is further configured to adjust the user model to suit a knowledge of a user.
